(19) United States
(12) Patent Application Publication
(10) Pub. No.: US 2011/0220072 A1
(43) Pub. Date: Sep. 15, 2011

(54) Coaxial heat exchanger for a motor vehicle exhaust gas system

(75) Inventor: Lothar Seybold, Nauheim (DE)

(73) Assignee: GM GLOBAL TECHNOLOGY OPERATIONS LLC, Detroit, MI (US)

(21) Appl. No.: 13/043,768

(22) Filed: Mar. 9, 2011

(30) Foreign Application Priority Data
Mar. 9, 2010 (DE) 102010010624.0

(51) Int. Cl. F02G 5/02; F01N 5/02

(52) U.S. Cl. 123/543; 60/320

(57) ABSTRACT

A heat exchanger is provided for an exhaust gas system of a motor vehicle having a heat exchanger body, which can have a heat exchanger medium flow through it, and which is in permanent thermal contact with an exhaust gas train of an internal combustion engine of the motor vehicle, the heat exchanger body at least sectionally enclosing the exhaust gas train and being able to be fluidically coupled with a cooling loop of the internal combustion engine and/or with a transmission oil loop.

### CROSS-REFERENCE TO RELATED APPLICATION

This application claims priority to German Patent Application No. 102010010624.0, filed Mar. 9, 2010, which is incorporated herein by reference in its entirety.

### TECHNICAL FIELD

The technical field relates to a heat exchanger for an exhaust gas system of a motor vehicle, in particular for heating up an internal combustion engine in its cold start phase.

### BACKGROUND

It is possible to reclaim thermal energy from combustion exhaust gases of an internal combustion engine for the purpose of heating the internal combustion engine during its cold start phase using heat exchangers for exhaust gas systems. Known heat exchanger arrangements provide applying combustion exhaust gases directly to at least one fluid-conducting pipe of the heat exchanger and situating the fluid-conducting pipe in the interior of the exhaust gas train for this purpose.

It is unavoidable that the fluid-conducting pipe is led through the wall of the exhaust gas train. Since, after reaching the operating temperature, further thermal energy reclamation from the exhaust gases and thermal energy supply to the internal combustion engine are undesirable and would even be disadvantageous for the cooling of the engine which is then required, in typical exhaust gas energy reclamation systems it is provided that the exhaust gas train is branched and the heat exchanger is only provided on an exhaust gas train to which the exhaust gas can optionally be applied using an exhaust flap for thermal energy reclamation. Such a heat exchanger for an exhaust gas system is described, for example, in DE 41 41 556 A1.

The provision of exhaust flaps, valves, or similar control elements to be mechanically actuated in the exhaust gas train has proven to be complex and in particular also susceptible to failure because of the temperatures prevailing in the exhaust gas train. In addition, mechanical or electromechanical activators, including control units, are required for such positioning or control means situated in the exhaust gas train. The implementation of such mechanical or electromechanical control and regulating elements to be situated in the exhaust gas train is comparatively complex to produce and install and also has a disadvantageous effect on the total vehicle weight and the production costs.

In addition, leading fluid-conducting pipes of the heat exchanger through wall sections of the exhaust gas train is problematic. The thermal conditions prevailing in or on the exhaust gas train place extremely high demands on the materials and components which are to be used for the exhaust gas train and also for the fluid-conducting heat exchangers. The exhaust gas train and also the fluid-conducting pipes of the heat exchanger in thermal contact therewith can be the object of corrosion. In the event of a leak in the fluid-conducting heat exchanger, the loss of the heat exchanger medium, for example, cooling water of the internal combustion engine is a concern, so that damage to the heat exchanger and/or the exhaust gas system can sometimes also negatively influence the cooling function of the internal combustion engine.

Accordingly, at least one object is to provide a heat exchanger for an exhaust gas system of a motor vehicle, which has a simple and robust construction, is cost-effectively producible and simple to install, and is implementable substantially without movable control elements to be situated directly on the exhaust gas train. In addition, other objects, desirable features and characteristics will become apparent from the subsequent summary and detailed description, and the appended claims, taken in conjunction with the accompanying drawings and this background.

### SUMMARY

The heat exchanger according to an embodiment of the invention is provided for an exhaust gas system of a motor vehicle and has a heat exchanger body through which a heat exchanger medium can flow. This body is in permanent thermal contact with an exhaust gas train of an internal combustion engine of the motor vehicle. The heat exchanger body at least sectionally encloses the exhaust gas train and is implemented to be hermetically separated therefrom.

The heat exchanger body can be fluidically coupled to a cooling loop of the internal combustion engine and/or to a transmission oil loop. The embodiment is therefore universally capable of heating the engine block and also a vehicle transmission and usable for this purpose.

Improved mechanical decoupling of heat exchanger and exhaust gas train can be achieved by the arrangement of the heat exchanger body enclosing the exhaust gas train. The heat exchanger or heat exchanger components therefore no longer have to penetrate wall sections of the exhaust gas train. Exhaust gases are no longer directly applied to the heat exchanger in this case. However, in practice sufficient thermal coupling to the heat exchanger can be provided using the direct thermal contact with the exhaust gas train.

The heat exchanger body can thus fundamentally also be retrofitted in existing exhaust gas systems, in that it is externally installed on a preferably cylindrical pipe section of the exhaust gas train. The heat exchanger body is preferably implemented as a hollow cylinder in this case, in order to be able to receive the exhaust gas train for the purpose of thermal coupling, on the one hand, and have heat exchanger medium flowing through it in this section, on the other hand.

A particularly robust thermal coupling, which is less susceptible to failure, of exhaust gas train and heat exchanger can be provided by the arrangement of the heat exchanger body enclosing the exhaust pipe or the exhaust gas train in the radial direction. Such a hermetic separation has the advantage that in the event of corrosion-related damage of the exhaust gas train, for example, the heat exchanger body can remain intact, so that a loss of heat exchanger medium, such as cooling water, can be substantially prevented.

According to an embodiment, it is provided that the fluidic coupling of the heat exchanger body to the cooling loop of the internal combustion engine and/or to the transmission oil loop is variable as a function of the prevailing temperature of the heat exchanger medium. It is advantageously provided that the fluidic coupling is canceled upon reaching or exceeding a predefined limiting temperature. Mechanically adjustable control and regulating elements in the exhaust gas train itself can thus advantageously be dispensed with.

Through the fluidic decoupling of the heat exchanger from the cooling loop of the internal combustion engine, or from the transmission oil loop, the supply of thermal energy or the thermal energy reclamation of the combustion exhaust gas can solely be implemented using fluid-conducting components of the heat exchanger or the downstream cooling loop.

According to a geometric embodiment, it is provided that the heat exchanger body at least regionally coaxially encloses the exhaust gas train. The heat exchanger is therefore implemented as a tubular coaxial heat exchanger, an inner pipe, namely the exhaust gas train viewed in the radial direction, being at least sectionally enclosed by an outer pipe, namely the heat exchanger body. The intermediate space between exhaust gas train and heat exchanger body, or the ring-shaped or hollow-cylindrical chamber of the heat exchanger body which encloses the exhaust gas train, is provided with at least one inflow and with one outflow for the heat exchanger medium which circulates between heat exchanger and engine radiator.

According to an embodiment, it is provided that the heat exchanger body can be decoupled from the cooling loop or from the transmission oil loop using a four-way valve in the event of a rise of the temperature of the heat exchanger medium above a predefined limiting value.

For the variable coupling or decoupling or for actuating the four-way valve, a regulating element is provided according to an embodiment, which regulates the fluidic coupling of the heat exchanger body and the fluid loop as a function of temperature. An active or passive control element, a thermostat, a pneumatic actuator, or an electromechanical actuator is to be provided as the regulating element. The four-way valve is preferably adjustable using a thermostat.

According to a further embodiment, it is provided that the heat exchanger body, the four-way valve, and associated fluidic connection means are implemented as essentially pressure-resistant. In the event of decoupling of the heat exchanger from the cooling loop of the internal combustion engine or from the transmission oil loop, the inflow and the outflow of the heat exchanger are preferably to be short-circuited with one another. In order that the heat exchanger medium contained in the heat exchanger body and in the associated inflows and outflows does not escape in an uncontrolled way, the heat exchanger bodies are to be implemented as sufficiently pressure-resistant to be able to withstand a pressure increase of the heat exchanger medium caused by a rise of the temperature of the exhaust gas train in continuous operation of the internal combustion engine.

Furthermore, it is provided according to a further embodiment that the four-way valve short-circuits the transmission oil loop and/or the heat exchanger loop in the event of decoupling of heat exchanger body and cooling loop, or transmission oil loop, respectively. In this decoupling configuration, both inflow and outflow of the heat exchanger body are preferably fluidically connected to one another while bypassing the cooling loop.

It can similarly be provided that the inflows and outflows, which open into the four-way valve, of the cooling loop or the transmission oil loop are coupled to one another to conduct fluid while bypassing the heat exchanger body. Corrosion-related leakage on the heat exchanger body can even occur in this decoupled configuration, which would not have any direct effect on the cooling loop in continuous operation of the vehicle.

Only the heat exchanger medium contained in the heat exchanger body and its inflows and outflows could escape. The actual cooling loop or transmission oil loop would remain intact in the event of a leak in the heat exchanger, however, and impairment of the cooling function of the cooling loop or the transmission oil loop would not be a concern.

Furthermore, it is provided according to an embodiment that the heat exchanger loop, comprising the heat exchanger body, its inflows and outflows, and the four-way valve, has at least one overpressure emergency relief device. The emergency relief device allows a controlled escape of the heat exchanger medium for the case in which the pressure in the interior of the heat exchanger loop exceeds permissible limiting values, otherwise damage or even bursting of heat exchanger loop components being a concern.

According to a further embodiment, it is particularly provided that the exhaust gas train is implemented as flap-free and/or bypass-free. Because thermal coupling and decoupling of heat exchanger body and cooling loop can exclusively occur via a thermostat-controlled four-way valve and the heat exchanger body is to be designed in such a way that it withstands temperatures occurring in operation of the internal combustion engine in the exhaust gas train, both a branching bypass line in the exhaust gas train and an associated exhaust flap mechanism can finally be dispensed with in a way which saves costs and space.

An electromechanical activator can advantageously also be dispensed with by providing a thermostatic regulation. The coupling and decoupling of heat exchanger body and cooling loop of the internal combustion engine occurs directly as a function of the temperature of the heat exchanger medium.

For the case in which an overpressure-safe design of the heat exchanger loop is not to be considered, according to a further embodiment, the heat exchanger body can be in permanent thermal contact with an exhaust gas train, which can have exhaust gas variably applied thereto using an exhaust flap. The application of thermal energy derived from the exhaust gas to the heat exchanger body is performed in this case via a change of the flap setting.

According to a further embodiment, a method is provided for heating up an internal combustion engine of a motor vehicle, in particular in its cold start phase, using a heat exchanger. In this case, exhaust gas heat is discharged to the heat exchanger medium using the heat exchanger body, which is in thermal contact with an exhaust gas train and can have a heat exchanger medium flow through it, and the heat is supplied via a disconnectable fluid coupling to a cooling loop of the internal combustion engine and/or a transmission oil loop.

Upon reaching or exceeding a predefined limiting temperature of the heat exchanger medium, which is reached in particular when the internal combustion engine assumes its operating temperature, the coupling of the heat exchanger body to the cooling loop or to the transmission oil loop is canceled. For this purpose, a four-way valve is used, which preferably alternately couples both loops, cooling loop and heat exchanger loop, to one another and is to be actuated using a thermostat.

In a further embodiment, a motor is provided vehicle having an above-described heat exchanger.

### BRIEF DESCRIPTION OF THE DRAWINGS

The present invention will hereinafter be described in conjunction with the following drawing figures, wherein like numerals denote like elements, and:

FIG. 1 shows a schematic, greatly simplified view of a coaxial heat exchanger situated on an exhaust gas train;

FIG. 2 shows a cross-section through the exhaust gas train-heat exchanger arrangement according to FIG. 1;

FIG. 3 shows a schematic view of a further embodiment of the invention having a heat exchanger body, which can be fluidically decoupled from a cooling loop, in a passage position; and

FIG. 4 shows the valve arrangement according to FIG. 3 in the decoupled configuration.

### DETAILED DESCRIPTION

The following detailed description is merely exemplary in nature and is not intended to limit application and uses. Furthermore, there is no intention to be bound by any theory presented in the preceding background or summary or the following detailed description.

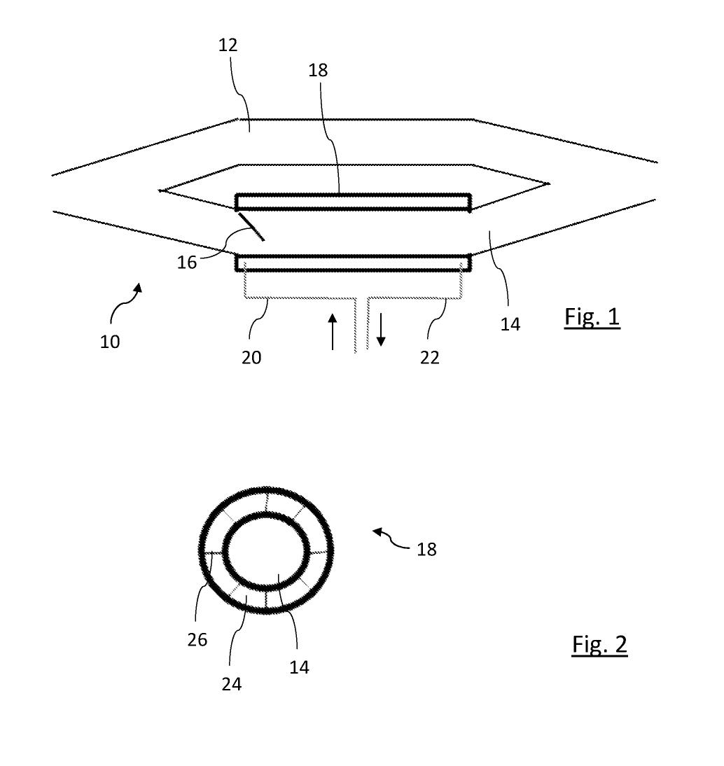

An exhaust gas heat exchanger arrangement 10 is shown in simplified form in FIG. 1. The exhaust gas arrangement of an internal combustion engine (not explicitly shown) is divided in the area shown here into two branches 12, 14, of which one branch 14 is at least regionally enclosed by a heat exchanger body 18. A corresponding cross-section through the branch 14 is shown in FIG. 2. The heat exchanger body 18 encloses the exhaust gas train 15 in the peripheral direction and has individual chambers 24, through which a heat exchanger medium, such as cooling water, can flow.

As shown in FIG. 2, the heat exchanger body 18, of essentially cylindrical design, can be supported on the exhaust gas train 15 via webs 28 which are oriented radially inward. In addition to increasing the stability of the overall arrangement of heat exchanger body 18 and exhaust gas train 15, the webs 26, which extend in the pipe longitudinal and radial directions, increase the surface around which the heat exchanger medium can flow.

Furthermore, an inflow 20 and an outflow 22 for the heat exchanger medium are shown in FIG. 1, using which the heat exchanger body 18 has a fluid-conducting connection to the cooling loop of the internal combustion engine. In a cold start phase of the internal combustion engine, the correspondingly cold heat exchanger medium can be heated via the wall of the exhaust gas train 15, which is heated relatively rapidly by the combustion exhaust gas, and supplied to the internal combustion engine for the heating thereof to its operating temperature.

The exhaust gas train 15 is further provided with an exhaust flap 16, which can change the cross-section of the exhaust gas train 15 through which exhaust gas can flow with the aid of a corresponding control drive (not shown), in order to regulate a heat exchange between exhaust gas train 15 and heat exchanger medium. When the exhaust flap 16 is completely closed, all of the exhaust gas necessarily flows through the remaining branch 12 of the exhaust gas system.

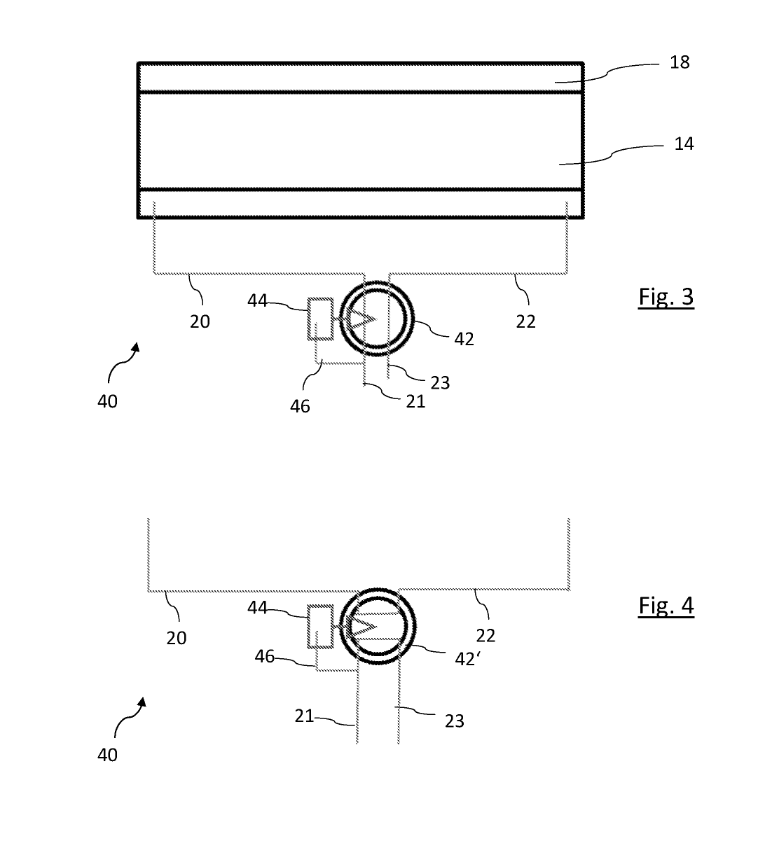

A supplementary or alternative embodiment of a heat exchanger 40 for an exhaust gas system of a motor vehicle is shown in FIG. 3 and FIG. 4. Similarly to the embodiment according to FIG. 1 and FIG. 2, a heat exchanger body 18 also encloses an exhaust gas train 15 here. The exhaust gas train 15 or the exhaust gas system can be implemented completely without flaps or bypasses here, however, since extensive thermal decoupling of heat exchanger 40 and a cooling loop (not explicitly shown) of the internal combustion engine is implemented solely using fluidics.

Specifically, the fluid-conducting heat exchanger loop can be decoupled from the cooling loop of the internal combustion engine using a four-way valve 42. The four-way valve 42 is preferably actuated via a thermostat 44, which is preferably in permanent thermal contact with an outlet 21 of the cooling loop via a stub line 46. As soon as the heat exchanger medium flowing in the cooling loop, for example, the cooling water, exceeds a predefined temperature, a wax element, which is situated inside the thermostat and melts at the predefined temperature, for example, causes a rotation of the four-way valve 42 into the configuration 42′ shown in FIG. 4.

In the arrangement shown in FIG. 4, the inflow 20 and the outflow 22 of the heat exchanger body 18 are quasi-short-circuited via the four-way valve 42′, and are therefore directly fluidically connected to one another. This is performed in this case using the inflow 20 and the outflow 23 of the cooling loop provided for the internal combustion engine. This loop is also quasi-short-circuited, in any case, however, fluidically decoupled from the loop of the heat exchanger body, which is now closed.

In the embodiment according to FIG. 3 and FIG. 4, movable components are now no longer required in the exhaust gas stream. A bypass line in the exhaust gas stream is obsolete. There is also no longer any direct intervention in the exhaust gas stream of the engine in this case. Known disadvantages of common exhaust flap mechanisms, for example, an exhaust-side pressure loss of the exhaust gas system and increased installation space requirement for the actuators and the bypass line, can thus be avoided.

The variable fluidic coupling of heat exchanger body 18 to the cooling loop of the internal combustion engine, which is shown in FIG. 3 and FIG. 4, also proves to be advantageous before the background of weight and cost reduction.

It is only necessary in this case to dimension and implement the heat exchanger loop, i.e., the heat exchanger body 18, its inflow 20 and outflow 22, and the four-way valve 42, in such a way that they withstand a pressure increase of the heat exchanger medium caused by exhaust-related heating of the exhaust gas train 15.

The illustrated embodiments only show a possible design of the invention, for which numerous further variants are conceivable and within the scope of the invention. The exemplary embodiments shown as examples are in no way to be understood as restrictive with respect to the scope, the applicability, or the configuration possibilities of the invention. The present invention merely discloses a possible implementation of an exemplary embodiment according to the invention to a person skilled in the art. Manifold modifications can be performed on the function and arrangement of described elements without leaving the scope of protection defined by the following patent claims or its equivalents in this case.

1. A heat exchanger for an exhaust gas system of a motor vehicle, comprising:
an exhaust gas train of an internal combustion engine of the motor vehicle;
a heat exchanger body in thermal contact with the exhaust gas train and configured to receive a flow of a heat exchanger medium, the heat exchanger body at least sectionally enclosing the exhaust gas train; and
a loop fluidically coupled to the heat exchanger body.

2. The heat exchanger according to claim 1, wherein fluidic coupling of the heat exchanger body with the loop is variable as a function of a prevailing temperature of the heat exchanger medium.

3. The heat exchanger according to claim 1, wherein the heat exchanger body at least regionally coaxially encloses the exhaust gas train.

4. The heat exchanger according to claim 1, wherein the heat exchanger body is configured to decouple from the loop using a four-way valve if a temperature of the heat exchanger medium rises above a predefined limiting value.

5. The heat exchanger according to claim 4, further comprising a regulating element configured for temperature-dependent fluidic coupling of the heat exchanger body with the loop.

6. The heat exchanger according to claim 5, wherein the four-way valve is adjustable using the regulating element.

7. The heat exchanger according to claim 6, wherein the heat exchanger body, the four-way valve, and an associated fluidic connector are implemented as essentially pressure-resistant.

8. The heat exchanger according to claim 6, wherein the four-way valve is configured to short-circuit the loop in event of a decoupling of the heat exchanger body and the loop.

9. The heat exchanger according to claim 1, wherein the loop comprises an overpressure emergency relief device.

10. The heat exchanger according to claim 1, wherein the exhaust gas train is free of flaps.

11. The heat exchanger according to claim 1, wherein the heat exchanger body is in thermal contact with the exhaust gas train configured to variably apply exhaust gas using an exhaust flap.

12. A method for heating an internal combustion engine of a motor vehicle in a cold start phase using a heat exchanger, comprising:
discharging exhaust heat to a heat exchanger medium;
supplying the heat exchanger medium via a disconnectable coupling to a loop using a heat exchanger body in thermal contact with an exhaust gas train and configured to receive a flow of the heat exchanger medium; and
cancelling the a coupling of the heat exchanger body with the loop upon at least reaching a predefined limiting temperature of the heat exchanger medium.

13. (canceled)

14. The heat exchanger according to claim 1, wherein the loop is a cooling loop of the internal combustion engine.

15. The heat exchanger according to claim 1, wherein the loop is a transmission oil loop.

16. The heat exchanger according to claim 1, wherein the exhaust gas train is free of bypasses.

17. The method according to claim 12, wherein the loop is a cooling loop of the internal combustion engine.

18. The method according to claim 12, wherein the loop is a transmission oil loop.
